(19) United States
(12) Patent Application Publication
(10) Pub. No.: US 2003/0225608 A1
(43) Pub. Date: Dec. 4, 2003

(54) Valued knowledge management system

(75) Inventors: Shang-Che Wu, Hsinchu (TW); Wei-Ming Chen, Taipei (TW)

Correspondence Address: BACON & THOMAS, PLLC, 625 SLATERS LANE, FOURTH FLOOR, ALEXANDRIA, VA, 22314

(73) Assignees: Shang-Ce WU, Hsinchu (TW); Wei-Ming CHEN, Taipei (TW); Hung-Sheng HSU, Taipei (TW)

(21) Appl. No.: 10/154,366

(22) Filed: May 28, 2002

(51) Int. Cl. G06F 17/60

(52) U.S. Cl. 705/10

(57) ABSTRACT

The present discloses a valued knowledge management system to automatically calculate usefulness values of particular knowledge, to display said usefulness values and to operate transactions of selected knowledge in response to selection instructions. The valued knowledge management system comprises: a usefulness assessment module to analyze content of particular knowledge, to compare fragments of particular knowledge with an accessible data and to calculate usefulness assessment value of said particular knowledge; a usefulness display module to display indication of said particular knowledge, said usefulness assessment value and description of method of said assessment; and a knowledge transaction module to operate transaction of selected knowledge in response to a selection instruction pertaining to said particular knowledge and to provide content of said knowledge after said transaction is completed.

### FIELD OF INVENTION

This invention relates to a valued knowledge management system, especially to a transaction management system for valued knowledge.

### BACKGROUND OF INVENTION

While the world has stepped into the information technology (IT) era, the transaction of knowledge will become an important part of the transaction activity of the world. Although in the past the value of knowledge has been respected, however, knowledge is sold as it is affixed to a medium or is provided along with service. This type of transaction of knowledge is not changed even in the present time when so-called “e-commerce” has become popular in the industry. The mass transaction of pure knowledge in the form of “information” or “data” is still an idea that is difficult to realize. As a result, to show the value of knowledge to potential buyers and to provide knowledge in order to obtain rewords thereto through the internet, has become a task in the field of the e-commerce.

The major difficulty of the mass transaction of valued knowledge in the form of pure information or data rests in the dilemma of the valued information per se.

The value of knowledge comes from the “usefulness” of the knowledge in relation to its buyers. Whether a knowledge is “useful” or not, shall be determined subjectively. To be successful in a transaction of knowledge, it is necessary to let the potential buyers to “believe” or to “determine” that the knowledge is useful. Although there are many possible approaches to persuade the potential buyer to believe that particular knowledge is useful to him/her, which includes the description of the usefulness of the knowledge and the trustworthiness of the knowledge provider, the most direct and persuasive way shall be the direct disclosure of the content of the knowledge.

However, one characteristic of knowledge is that the value of the knowledge will be null, once the content of the knowledge is disclosed, since, after the disclosure, the buyer has become aware of the knowledge. I.e., the valued knowledge becomes valueless knowledge.

In many transaction management systems for valued knowledge, the protection of intellectual properties rest in the knowledge to be traded, i.e., the prevention of reproduction of knowledge, is their major task. However, for pure knowledge, its content is short and simple. Most tools for intellectual property protection can not provide sufficient protection. For such information, the dilemma of the proof of the value of the knowledge and the value of the knowledge itself is the most difficult part in the transaction of valued knowledge.

It is thus necessary to provide a novel valued knowledge management system wherein the possible value of the knowledge may be represented by numeric values, without the need to disclose the content of the knowledge, so to encourage a potential buyer to enter into a transaction.

### OBJECTIVE OF INVENTION

The objective of this invention is to provide a novel valued knowledge management system whereby the possible value of the knowledge may be represented by numeric values, without the need to disclose the content of the knowledge, so to encourage a potential buyer to enter into a transaction.

### SUMMARY OF INVENTION

According to the valued knowledge management system of the present invention, the usefulness of knowledge may be assessed through formulas or inference rules. The assessed values of the usefulness of the knowledge are displayed, while the content of the knowledge is hidden until an instruction of transaction is made by a user. Upon such instruction, the content of the knowledge is disclosed to the buyer. The valued knowledge management system of this invention comprises:

A usefulness assessment module to use at least one digitized assessment means to asses the usefulness of particular knowledge; wherein said usefulness assessment comprises the assessment of correctness, richness, population of past buyers, frequency of being quoted and other quantifiable features that support the usefulness assessment of the knowledge;

An assessment display module to display the methods of usefulness assessment and the values of the assessments; and

A knowledge transaction module to complete a transaction of particular knowledge upon the instruction of a potential buyer and to provide said particular knowledge.

This and other objectives and advantages of the present invention may be clearly understood from the detailed description by refereeing to the following drawings.

### BRIEF DESCRIPTION OF DRAWINGS

FIG. 1 illustrates the system diagram of the valued knowledge management system of this invention.

FIG. 2 shows the user interface of a stock price prediction website using the valued knowledge management system of this invention.

FIG. 3 illustrates the operational flow chart of a valued knowledge transaction of the valued knowledge management system of this invention.

### DETAILED DESCRIPTION OF INVENTION

The following is a detailed description of the valued knowledge management system of this invention.

The valued knowledge management system of this invention comprises: a usefulness assessment module to automatically assess usefulness of particular knowledge, a usefulness display module to display the usefulness assessment values of said particular knowledge and a knowledge transaction module to complete a transaction of knowledge and to display content of said knowledge in response to the instruction of a user.

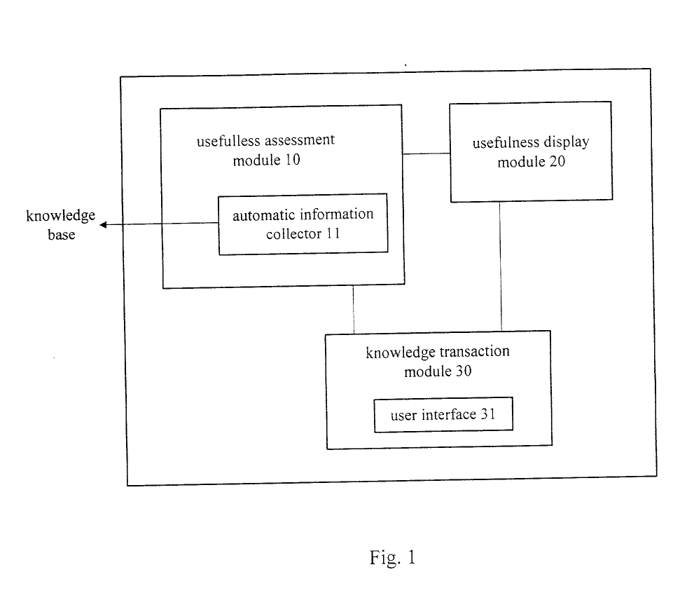

FIG. 1 illustrates the system diagram of the valued knowledge management system of this invention. As shown in this figure, the valued knowledge management system of this invention comprises a usefulness assessment module 10, a usefulness display module 20 and a knowledge transaction module 30.

The usefulness assessment module 10 of this invention automatically assess the usefulness of particular knowledge according to a digitized assessment method.

To accomplish this purpose, the usefulness assessment module 10 provides an automatic information collector 11 to collect in connectable websites (not shown) information provided in said websites that is relative to fragments of content of particular knowledge, to obtain fragments of said relative information, to compare said fragments of said information with said fragment of said particular knowledge and to calculate value of correctness of said particular knowledge according to said fragment of said information. The information collector 11 may also collect digital evaluations made by users in connection to said particular knowledge. The information collector 11 may also collect entry rate of the particular knowledge, quantity (richness) of data contained in said particular knowledge or other numeric values that may represent usefulness of said particular knowledge in respective aspects. The numeric values so obtained are then calculated, inferred or compared according to particular rules to generate values of usefulness assessment of the knowledge. The values of usefulness assessment are then output to the usefulness display module 20 according to the method of assessment or the categories of the assessments to be displayed.

The usefulness display module 20 provides a display, obtains said usefulness assessment values and displays the assessment values in categories.

The knowledge transaction module 30 provides a knowledge transaction user interface 31 on which the representative codes or other description of particular knowledge, the methods of assessment and the value of the usefulness assessment are displayed, allowing users to select.

After a user selects particular knowledge by clicking representative code of said particular knowledge on said knowledge transaction user interface 31. Upon such selection, the knowledge transaction module 30 obtains the personal information of said user, collects the payment of said user according to predetermined transaction rules, and displays the content of said particular knowledge after the payment is determined having been collected.

The valued knowledge applicable in the valued knowledge management system of this invention includes all kinds of information existing in the format of text, symbol, sound, graphics, motion pictures and other media.

In order to describe the present invention, a stock price prediction website using the valued knowledge management system of this invention is taken for example.

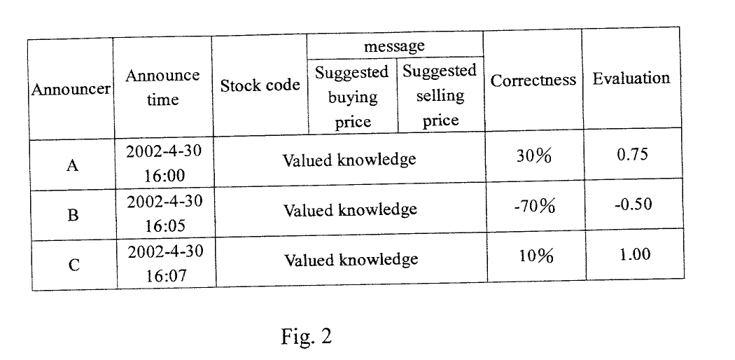

FIG. 2 shows the user interface of a stock price prediction website using the valued knowledge management system of this invention. As shown in this figure, in the user interface a plurality of articles or messages that predict the variation of stock prices are displayed. Columns of the information of one particular article or message include: announcer, announce time, message, correctness, evaluation etc. Among them:

In the column of “announcer”, displayed is name of announcer, representative code or announcer or nickname of announcer. The information as displayed is obtained from the column of “announcer” as input by the announcer when he/she inputs the message.

In the column of “announce time”, displayed is the time when the announcer inputs the message. The information as displayed is obtained form the current time in the clock of the computer system that receives the message.

In the column of “message”, information contained therein may include suggestions in buying price, selling price and/or margin of profit or loss, or predictions of stock price, of a particular stock A message in general includes the following information:

Stock and its code in the stock exchange: The information in this column is the stock and its code as input by the announcer and may include other corresponding data as stored in a stock-code look-up-table.

Suggested buying price: The information in this column is a value as input by the announcer.

Suggested selling price: The information in this column is a value as input by the announcer.

Other suggestions: The information contained in this column may include all kinds of modelized information, such “bull market”, “bear market” etc., and other comments or suggestions that may not be modelized.

When a message is classified as “valued information” by the announcer, the content of the column of “message” is replaced by “valued information” when it is displayed for transaction. The content of the message is not shown in the user interface 31. If a message is not classified as “valued information” the content of the message is displayed. Such a message is not “valued knowledge”.

In the column of “correctness” displayed is value of correctness of the suggestion or prediction as announced by an announcer For example, when a message suggests to buy a stock at the price of 20 dollars and to sell it at the price of 30 dollars, if the price of the stock later appreciates from 20 dollars to 25 dollars, the correctness of this message may be calculated according to the following formula:

(current price−suggested buying price)/(suggested selling price−suggested buying price)=correctness (1)

In this example, the correctness is +50%.

In the applications the basis of the correctness is not necessarily the current price of the stock The closing price of the previous transaction day may also be the basis.

In addition to the factors as shown in Formula 1, other factors such as time intervals, turnovers of a stock and other available data may also be taken for consideration in the calculation of the correctness. Since there are many merchandises available in the stock market, the factors used in the calculation of the correctness of a message are preferably those that can be obtained automatically from resources such as the internet. More preferably the factors are numeric values.

In the column of “evaluation”, displayed is the grade of evaluation to the message. The evaluation may be in the format of text, graphics or other identification of evaluation. In an embodiment of this invention, the evaluation is based on evaluations made by buyers of the message. For example, the sum of grading of evaluation of all buyers may be a reference in the evaluation of the message, as follows:

Evaluation=Σevaluation i (2)

Wherein “Evaluation” is the value of this column and “evaluation i” represents the grade of evaluation given by the ith buyer.

Another possible way to give evaluation is to divide the sum of the evaluation grades with the total number of buyers who give the evaluation, as follows:

Evaluation=(Σevaluation i)/n (3)

Wherein “Evaluation” represents the value of this column, “evaluation i” represents the grade of evaluation given by the ith buyer and n represents the total number of buyers who give the evaluation.

In the above formula, the grade may be only 1, 0 or −1.

Other methods of evaluation are applicable in this invention, as long as they can give evaluation to a message based on one or more evaluation methods.

While the above columns are displayed in the user interface 31, any user may determine whether a message is “useful” to him/her according to information shown in the columns of “correctness”, “evaluation”, “announcer” etc. When a message is determined useful, the user may click on the indication of the message to purchase.

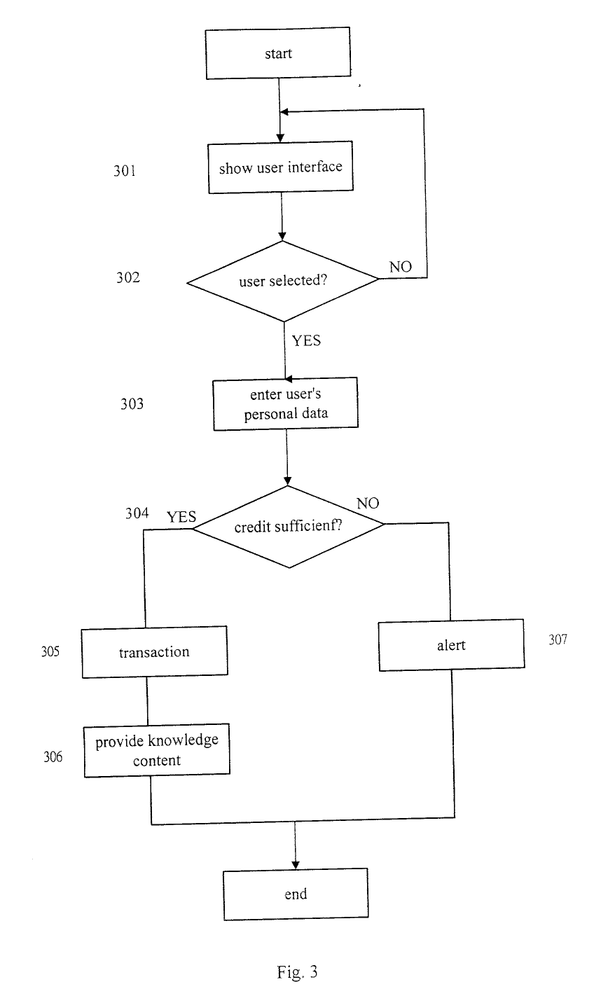

When a message is selected by a user, the knowledge transaction module 30 will operate to complete the transaction of the valued knowledge rest in the message. FIG. 3 illustrates the operational flow chart of a transaction of valued knowledge under the valued knowledge management system of this invention As shown in this figure, at 301 a user interface as shown in FIG. 2 is displayed, wherein a plurality of messages labeled with “valued information” is displayed. The announcer, announce time, correctness and evaluation of the message are shown. For a message labeled “valued information”, the stock code, suggestions, suggested buying price and suggested selling price are hidden. At 302 the user selects a message announced by Announcer A, because the user believes that the suggestions made by Announcer A in the past are of high value. At 303 the knowledge transaction module 30 displays a message, asking the user to key-in his/her user name, password and/or other information. At 304 the knowledge transaction module 30 identifies the user and checks the balance of the user's credit line, to see if the balance is sufficient to pay for the transaction at 305. If the balance is sufficient, the knowledge transaction module 30 deducts the balance with the value of the knowledge at 306 and displays the content of the selected valued knowledge at 307. If the balance of the credit line is not sufficient, an alert is shown at 308 to remind the user to settle in a settlement operation and the operation is end.

### EFFECTS OF INVENTION

As described above, the valued knowledge management system of this invention provides a usefulness assessment module to use accessible information to automatically conduct the usefulness assessment of particular valued information. The assessed values of the valued information are then displayed, such that a user may determine the possible value or usefulness of the information by referring to the methods of assessment and the result of assessment, before he/she decides to enter into a transaction of the value information. The dilemma of value knowledge, i.e., the difficulty of evaluation and the disclosure of valued knowledge, may thus be solved.

The valued knowledge management system of this invention may be used in the management of all kinds of valued knowledge with information fragments that may be assessed objectively or subjectively.

As the present invention has been shown and described with reference to preferred embodiments thereof, those skilled in the art will recognize that the above and other changes may be made therein without departing from the spirit and scope of the invention.

What is claimed is:

1. A valued knowledge management system, comprising
a usefulness assessment module to analyze content of particular knowledge, to compare fragments of content of said particular knowledge with an accessible data and to calculate usefulness value of said particular knowledge;
a usefulness display module to display indication of said particular knowledge, said usefulness assessment value as calculated by said usefulness assessment module and description of method of said assessment; and
a knowledge transaction module to operate a transaction of said particular knowledge in response to a selection instruction pertaining to said particular knowledge and to provide content of said knowledge after said transaction is completed.

2. The valued knowledge management system according to claim 1, wherein said usefulness assessment value comprises correctness assessment value and correctness assessment value is calculated according to the similarity between the numeric value of a predictive fragment of said particular knowledge and the current numeric value of the targeted fact relating to said predictive fragment.

3. The valued knowledge management system according to claim 2, wherein said usefulness assessment module calculates said usefulness assessment value according to the following formula:
Correctness assessment value=(current numeric value of targeted fact−first predicted numeric value)/(second predicted numeric value−first predicted numeric value)*100%
Wherein said first and second predicted numeric values are numeric values contained in said predictive fragment.

4. The valued knowledge management system according to claim 2, wherein said usefulness assessment module calculates said usefulness assessment value according to the following formula:
Correctness assessment value=(current numeric value of targeted fact−numeric value of targeted fact at the time when said particular knowledge was generated)/(predicted numeric value−numeric value of targeted fact at the time when said particular knowledge was generated)*100%
Wherein said predicted numeric value is a numeric value contained in said predictive fragment.

5. The valued knowledge management system according to claim 1, wherein said usefulness assessment value comprises evaluation given to said particular knowledge by a third party.

6. The valued knowledge management system according to claim 1, wherein said usefulness assessment value comprises evaluation value given to said particular knowledge by a third party.

7. The valued knowledge management system according to claim 1, wherein said usefulness assessment value comprises sum of evaluation values given to said particular knowledge by third parties.

8. The valued knowledge management system according to claim 1, wherein said usefulness assessment value comprises the result of sum of evaluation values given to said particular knowledge by third parties, divided by total number of said third parties.

9. The valued knowledge management system according to claim 1, wherein said particular comprises a description divided into columns and wherein said particular knowledge comprises at least one suggested value and/or one predicted value.

10. The valued knowledge management system according to claim 9, wherein said particular knowledge comprises a code representing file address of target of relating to said predicted value in an accessible database.

11. The valued knowledge management system according to claim 1, wherein content of said particular knowledge is not displayed in said usefulness display module.
